(19) United States
(12) Patent Application Publication
(10) Pub. No.: US 2003/0062134 A1
(43) Pub. Date: Apr. 3, 2003

(54) Corrugating machine

(75) Inventor: Felix Titz, Weiherhammer (DE)

Correspondence Address: BROWDY AND NEIMARK, P.L.L.C., 624 Ninth Street, N.W., Washington, DC, 20001, US

(73) Assignee: BHS Corrugated Maschinen-und Anlagenbau GmbH, Weiherhammer (DE)

(21) Appl. No.: 10/235,941

(22) Filed: Sep. 6, 2002

(30) Foreign Application Priority Data
Sep. 6, 2001 (DE) 101 43 633.5

(51) Int. Cl. B31F 1/22; B31F 1/20

(52) U.S. Cl. 156/470; 156/471; 156/472; 156/210; 156/205

(57) ABSTRACT

A corrugating machine for the manufacture of sheets of corrugated board comprises a first manufacturing unit for the production of a first web of corrugated board, a second manufacturing unit for the production of a second web of corrugated board, a mounting unit, which is disposed downstream of the manufacturing units in a working direction, for non-adhesively bringing together the first web of corrugated board and the second web of corrugated board and a working unit, which is disposed downstream of the mounting unit, for jointly working the first web of corrugated board and the at least second web of corrugated board that lie on top of each other.

### BACKGROUND OF THE INVENTION

1. Field of the Invention

The invention relates to a corrugating machine for the manufacture of sheets of corrugated board.

2. Background Art

Corrugating machines for the manufacture of single-faced corrugated board or multi-layered corrugated board have been known for quite a while, for instance from U.S. Pat. No. 5,632,850. The output of a corrugating machine can be raised by increasing the velocity of the corrugated board. However, there are upper limits to this. If a further increase in production is intended, another separate corrugating machine must be made available.

### SUMMARY OF THE INVENTION

It is an object of the invention to embody a corrugating machine of raised manufacturing capacity.

The object is attained in a corrugating machine for the manufacture of sheets of corrugated board, comprising a first manufacturing unit for the production of a first web of corrugated board; at least a second manufacturing unit for the production of an at least second web of corrugated board; a mounting unit, which is disposed downstream of said manufacturing units in a direction of working, for non-adhesively bringing together the first web of corrugated board and the at least second web of corrugated board; and at least one working unit, which is disposed downstream of the mounting unit, for jointly working the first web of corrugated board and the at least second web of corrugated board which lie on top of each other. The gist of the invention resides in that at least two webs of corrugated board are produced separately, which are then brought together and worked jointly.

Further details of the invention will become apparent from the ensuing description of two exemplary embodiments, taken in conjunction with the drawing.

### BRIEF DESCRIPTION OF THE DRAWING

FIG. 1 is a view of a first portion of a corrugating machine according to a first embodiment;

FIG. 2 is a view of a second portion of a corrugating machine according to the first embodiment;

FIG. 3 is an illustration of a detail, on an enlarged scale, of two webs of corrugated board one above the other that have been brought together; and

FIG. 4 is a view of a second portion of a corrugating machine according to a second embodiment.

### DESCRIPTION OF THE PREFERRED EMBODIMENTS

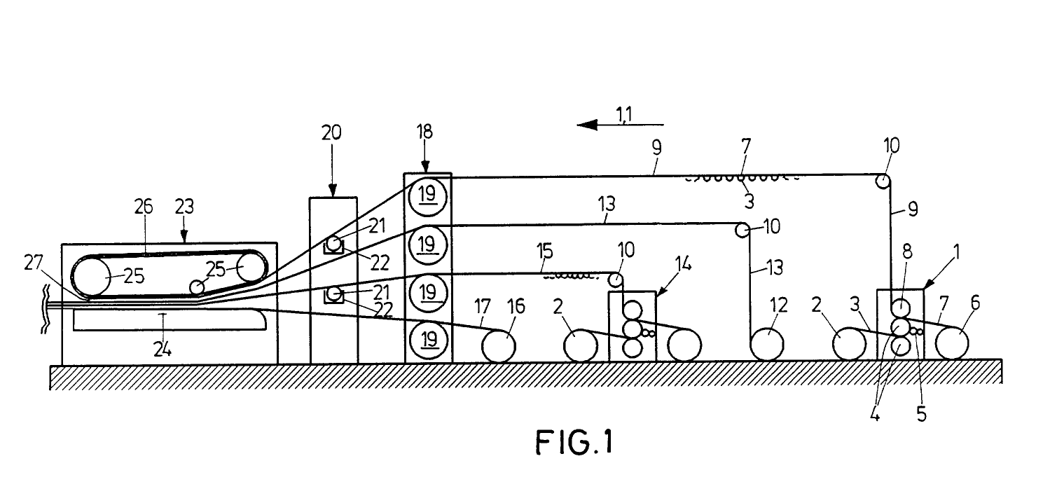

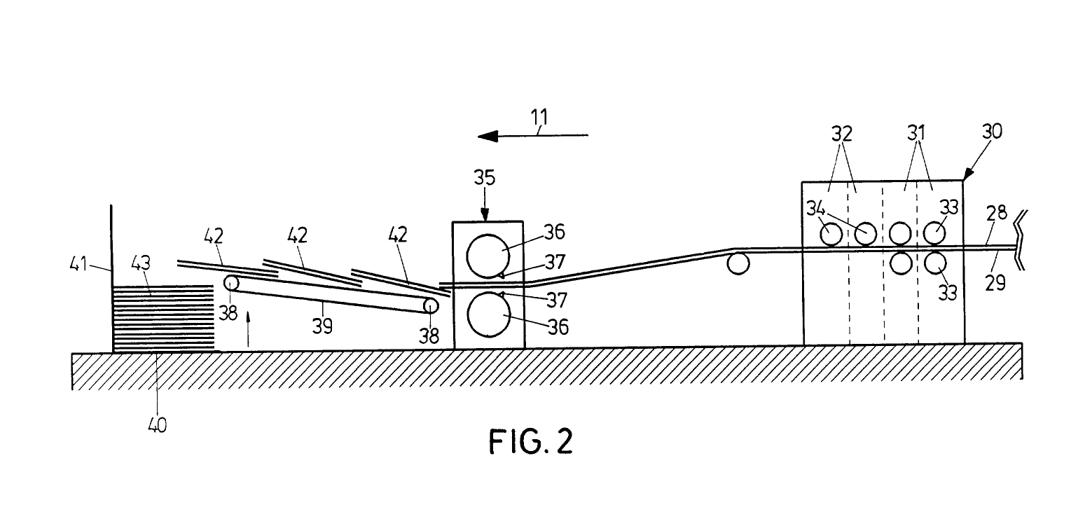

The following is a description of a first embodiment of the invention with reference to FIGS. 1 to 3. A corrugating machine, which is diagrammatically outlined in FIGS. 1 and 2, comprises a machine 1 for the manufacture of single-faced corrugated board. The machine 1 has an unroll stand 2 for a medium 3 which, for a corrugation to be produced, is passed between two neighboring fluted rollers 4. Then the tips of the corrugated medium 3 are glued in an adhesive applicator unit 5 and the corrugated medium 3 and a backer 7 from an unroll stand 6 are pressed together and joined in a nip between a nip roller 8 and a fluted roller 4. A single-faced corrugated board is discharged upwards from the machine 1 and deviated by a deflection roller 10 in a working direction 11. The machine 1 for the manufacture of single-faced corrugated board is generally known, for instance from U.S. Pat. No. 5,632,850, GB 2,305,675 A, or DE 43 05 158 A1, which reference is made to for any details.

An unroll stand 12 for a liner web 13 is disposed downstream of the machine 1 in the working direction 11, the liner web 13 first being led upwards and deviated by a deflection roller 10 and then conveyed in the working direction 11. The corrugated medium 3, the backer 7 and the liner 13 are appropriately selected paper webs. Disposed downstream of the unroll stand 12 in the working direction 11 is a machine 14 for the production of a web of single-faced corrugated board 15, the machines 1 and 14 being identical in design. The web of corrugated board 15 is discharged upwards from the machine 14, deviated by the deflection roller 10 and then conveyed in the working direction 11. An unroll stand 16 for a liner web 17 is disposed downstream of the machine 14, the liner 17 being discharged in the working direction 11. A preheater 18 is disposed downstream of the unroll stand 16, having four heating rollers 19 one above the other. The web of corrugated board 9, the liner web 13, the web of corrugated board 15 and the liner web 17 run one above the other, partially contacting the respective heating rollers 19. Disposed downstream of the preheater 18 is an adhesive applicator unit 20 with two glue rollers 21 one above the other which are partially located in a glue pan 22. The corrugated mediums 3 of the webs of corrugated board 9 and 15 are in contact with the respective glue rollers 21.

Disposed downstream of the adhesive applicator unit 20 is a heater 23 which comprises a horizontal hot plate table 24 extending in the working direction 11. Provided above the table 24 is a heated, continuous hold-down belt 26 which is deflected by three rollers 25, with a nip 27 formed between the hold-down belt 26 and the table 24, where the web of corrugated board 9, the liner 13, the web of corrugated board 15 and the liner 17 are passed through and pressed together. A corresponding heater 23 is known from U.S. patent application Ser. No. 09/711,957.

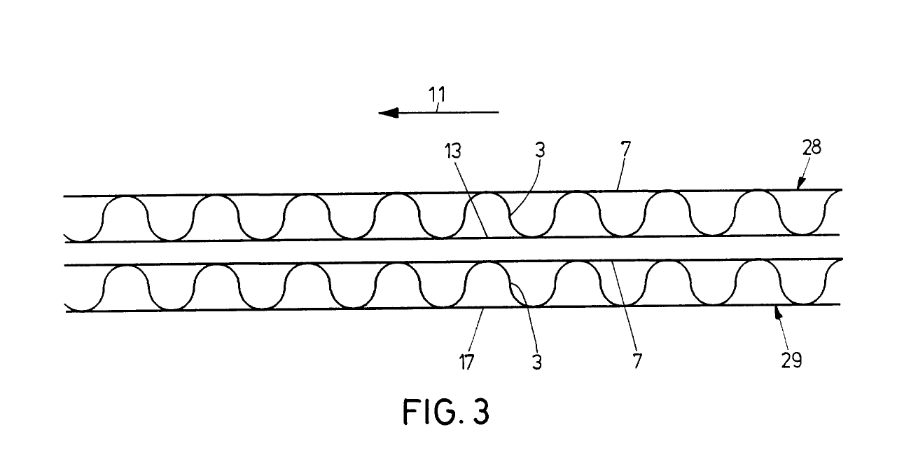

Two three-layered webs of corrugated board 28 and 29 are formed in the heater 23, lying one above the other without being glued. The arrangement of the two webs of corrugated board 28, 29 is illustrated in detail in FIG. 3, there being however no real gap between the webs of corrugated board 28 and 29 because the two webs lie directly one upon the other. The gap illustrates that the webs of corrugated board 28 and 29 are not united, but lie loosely one on top of the other.

The machine 1, the unroll stand 12, parts of the preheater 18 and of the adhesive applicator unit 20 as well as the part of the heater 23 necessary for adhesively mounting the web of corrugated board 9 to the liner 13 constitute a first manufacturing unit for the production of the web of corrugated board 28. The machine 14, the unroll stand 16, parts of the preheater 18 and of the adhesive applicator unit 20 as well as the part of the heater 23 necessary for adhesively mounting the web of corrugated board 15 to the liner 17 constitute the second manufacturing unit for the production of the web of corrugated board 29. The heater 23 is a mounting unit for non-adhesively bringing together the web of corrugated board 28 and the web of corrugated board 29.

Disposed downstream of the heater 23 is a lengthwise cutting/grooving unit 30, composed of two successive grooving stations 31 as well as two successive lengthwise cutting stations 32. The grooving stations 31 have grooving tools 33 which are disposed in pairs above each other with the webs of corrugated board 28 and 29 being passed there-between. The lengthwise cutting stations 32 have rotatably drivable cutters 34 for engagement with the webs of corrugated board 28, 29 for them to be cut longitudinally. The detailed structure of the grooving station 31 and the lengthwise cutting station 32 is known from U.S. Pat. No. 6,071,222 as well as DE 101 31 833.2, which reference is made to for information on the detailed design.

Downstream of the unit 30 in the working direction 11, provision is made for a crosscutting unit 35 which has two rotatably drivable rollers 36 one above the other, each carrying a cutter bar 37 that extends radially outwards vertically of the direction 11, the cutter bars 37 cooperating for crosscutting the webs 28 and 29. Provided directly downstream of the crosscutting unit 35 is a conveyor belt 39 that is deflected around rotatably drivable rollers 38. Downstream of the conveyor belt 39, provision is made for a deposit 40 with a vertical stop 41 where the corrugated boards 42 are piled up on a stack 43.

The following is a description of the mode of operation of the corrugating machine according to the first embodiment. In the machine 1, a web of single-faced corrugated board 9 is produced and supplied to the preheater 18 in the working direction 11. Simultaneously, the liner 13 is spun off the unroll stand 12 and also supplied to the preheater 18 in the direction 11. The same takes place in the machine 14 and with the liner web 17. In the preheater 18, the four webs 9, 13, 15 and 17 are initially heated and then the corrugated bottom sides of the webs 9 and 15 are glued in the adhesive applicator unit 20. In the heater 23, the liner web 13 is held down on the web of corrugated board 9 for them to be united. Simultaneously, the liner web 17 is pressed against the web of corrugated board 15 for these two to be united. In this way the three-layered webs of corrugated board 28 and 29 originate. It is also the function of the heater 23 to bring the webs of corrugated board 28 and 29 together so that two webs of corrugated board lie one on top of the other in the working direction 11 without the webs of corrugated board 28 and 29 being joined, in particular glued, together. In the stations 31,32 as well as the unit 35, the webs 28 and 29 that lie on top of each other are simultaneously worked by the grooving tools 33, the cutters 34 as well as the cutter bars 37. The advantage resides in that two webs of corrugated board 28, 29 that lie one on top of the other can be worked simultaneously by a lengthwise cutting/grooving unit 30 and a crosscutting unit 35, both of which are necessary for working a web of corrugated board. Consequently, twice the quantity of corrugated board can be worked while the number of working units 30, 35 and the velocity of the web of corrugated board remain the same. Downstream of the crosscutting unit 35, the corrugated boards 42 are imbricated on the conveyor belt 39 the corrugated boards 42 are imbricated on the conveyor belt 39 and stacked against the stop 41 on the deposit 40.

Even a higher number of webs of corrugated board can be brought together in the heater 23. It is conceivable to provide a third machine that is identical with the machine 1 as well as another unroll stand that is identical with the unroll stand 12 in order for three webs of corrugated board, which lie one on top of the other without being joined to each other, to be brought together in the heater 23, which is a factor three increase in output. It is also possible to bring together the webs of single-faced corrugated board 9 and 15 instead of the respective three-layered webs of corrugated board 28 and 29. In this case, there is no need of the liners 13 and 17 and the associated unroll stands 12 and 16. The heater 23 is not necessary for bringing together the webs of corrugated board 9 and 15. The webs of corrugated board 9 and 15 can be passed, and brought together, through a nip between two rollers that are disposed one above the other. The design of the mounting unit is a lot simpler in this case.

For the machine seen in FIG. 1 to be put into practice, resort may be made to an available machine for the manufacture of seven-layered corrugated board, with a corrugated medium being regularly arranged between two smooth paper webs in the seven-layered corrugated board. A machine for the manufacture of seven-layered corrugated board comprises three successive machines for the manufacture of single-faced corrugated board, with the first machine corresponding to the machine 1 and the third machine to the machine 14. The second machine is operated such that only the liner 13 is spun off, there being no corrugated medium.

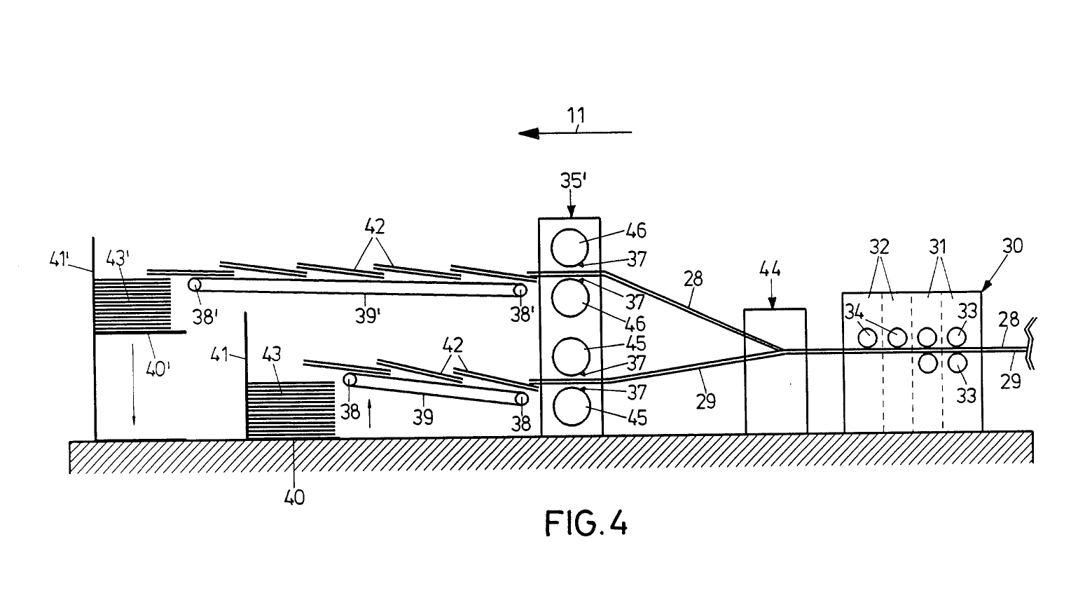

The following is a description of a second embodiment of the invention, taken in conjunction with FIG. 4. Identical parts have the same reference numerals as they have in the first embodiment, to the description of which reference is made. Parts that vary but are constructionally identical have the same reference numeral provided with a prime. The corrugating machine in the second embodiment is composed of the first portion according to FIG. 1 and the second portion according to FIG. 4. The essential difference from the first embodiment resides in that, downstream of the lengthwise cutting stations 32, a shunt 44 is inserted where the two webs of corrugated board 28 and 29 are again separated. They are respectively supplied to a lower pair of crosscutting rollers 45 and an upper pair of crosscutting rollers 46, the cutter bars 37 serving for crosscutting the web of corrugated board 28 and 29, respectively. The upper pair of rollers 46 is followed by another conveyor belt 39 which stacks the sheets of corrugated board 42 on the deposit 40′. The arrangement according to the second embodiment is necessary when the webs of corrugated board 28 and 29 are printed, and crosscutting the webs of corrugated board 28 and 29 cannot take place simultaneously and by the same cutter bars 37 as in the first embodiment. The arrangement according to the second embodiment serves to work printed webs of corrugated board 28 and 29, with the prints varying in position on the webs of corrugated board 28 and 29.

What is claimed is:

1. A corrugating machine for the manufacture of sheets of corrugated board (42), comprising
a) a first manufacturing unit for the production of a first web of corrugated board (28);
b) at least a second manufacturing unit for the production of an at least second web of corrugated board (29);
c) a mounting unit, which is disposed downstream of said manufacturing units in a direction of working (11), for non-adhesively bringing together the first web of corrugated board (28) and the at least second web of corrugated board (29); and
d) at least one working unit (30, 35; 30, 35′), which is disposed downstream of the mounting unit, for jointly working the first web of corrugated board (28) and the at least second web of corrugated board (29) which lie on top of each other.

2. A corrugating machine according to claim 1, wherein at least one of the first manufacturing unit and the second manufacturing unit comprises a unit (1, 14) for the manufacture of single-faced corrugated board (9, 15).

3. A corrugating machine according to claim 2, wherein at least one of the first manufacturing unit and the second manufacturing unit comprises unroll stands (12, 16) for a first liner web (13) and a second liner web (17).

4. A corrugating machine according to claim 3, wherein at least one of the first manufacturing unit and the second manufacturing unit comprise an adhesive applicator unit (20) for gluing the at least one web of single-faced corrugated board (9, 15).

5. A corrugating machine according to claim 4, wherein the mounting unit is a heater (23) for bringing together, pressing against each other and uniting at least one web of single-faced corrugated board (9, 15) and a liner web (13,17).

6. A corrugating machine according to claim 5, wherein the heater (23) is designed for non-adhesively bringing together the first web of corrugated board (28) and the at least second web of corrugated board (29).

7. A corrugating machine according to claim 1, wherein the working unit (30, 35; 30, 35′) comprises a lengthwise cutting unit (32) for jointly lengthwise cutting the first web of corrugated board (28) and the at least second web of corrugated board (29).

8. A corrugating machine according to claim 1, wherein the working unit (30, 35; 30, 35′) comprises a grooving unit (31) for jointly grooving the first web of corrugated board (28) and the at least second web of corrugated board (29).

9. A corrugating machine according to claim 1, wherein the working unit (30, 35) comprises a crosscutting unit (35) for jointly crosscutting the first web of corrugated board (28) and the at least second web of corrugated board (29).

10. A corrugating machine according to claim 1, wherein the working unit (30, 35′) comprises a crosscutting unit (35′) for separately crosscutting the first web of corrugated board (28) and the at least second web of corrugated board (29).
